(19) United States
(12) Patent Application Publication
(10) Pub. No.: US 2014/0373439 A1
(43) Pub. Date: Dec. 25, 2014

(54) MANUALLY INSTALLED AGRICULTURAL MULCH, DRIP IRRIGATION AND ROW COVER ASSEMBLY

(71) Applicants: Samuel Warner Finney, Philadelphia, PA (US); Keith Symmers Williamson, Hartsville, SC (US)

(72) Inventors: Samuel Warner Finney, Philadelphia, PA (US); Keith Symmers Williamson, Hartsville, SC (US)

(21) Appl. No.: 13/922,397

(22) Filed: Jun. 20, 2013

(51) Int. Cl. A01G 1/00; A01G 13/00; A01G 25/02

(52) U.S. Cl. CPC A01G 1/00; A01G 25/02; A01G 13/0275; A01G 13/0206
USPC 47/21.1

(57) ABSTRACT

An agricultural system includes an irrigation system, a mulch system including mulch material, and indicia disposed on the mulch material for indicating locations on the mulch material. The indicia include burial indicia, conduit warning indicia and plant spacing indicia. The planting spacing indicia are disposed in a triangular grid on the mulch system. The mulch material includes a hole for planting, a hole for a stake to pass there through, and a hole for a row cover support to pass there through. The irrigation system includes a drip irrigation conduit and a further conduit for transporting water to a further irrigation system. The irrigation system includes a fitting and a manifold for transporting water to the further conduit. At least a portion of the irrigation system is bonded to the mulch system, and at least a portion is enclosed and maintained in the vicinity of the mulch system by a sleeve.

This invention relates to provisional patent application #61/663831 filed Jun. 25, 2012.

### BACKGROUND OF THE INVENTION

1. Field of Invention

This invention relates to agricultural devices and in particular to mulching devices.

2. Description of Related Art

The present invention relates to agricultural irrigation systems and more particularly, to agricultural drip irrigation systems for small scale agriculture such as home gardens and small farms without mechanized equipment such as tractors or specialized agricultural implements.

Plant growers seek to maximize plant yields with a minimum amount of resource inputs. Typically in large scale agriculture, resource efficiency is the result of mechanization via the use of powered tractors and specialized agricultural implements. However, in small, non-mechanized situations found in home gardens, urban farms, and small truck-farm operations mechanization is not an economically viable option. Therefore, resource efficiency often comes from other sources, or from the traditions of farming in the pre-mechanical age.

A combination of sheet mulch and drip irrigation tubing is a mulching and watering technique employed to reduce labor and watering requirements on a modern farm and in home gardens. The soil is prepared for planting, and drip irrigation and sheet mulch can be applied to the surface. The sheet mulch serves to prevent weed growth between desired plants by blocking light and thereby preventing germination of weed seeds. The sheet mulch also aids in the retention of soil moisture and greatly reduces the volume of water required to maintain ideal growing conditions. The drip irrigation tubing serves to deliver water in a highly controlled fashion such that water is evenly distributed throughout the growing environment.

In the mechanized environment a tractor is employed with a mulch-layer that simultaneously installs drip irrigation tubing and buries the edges of sheet mulch to secure the mulch against environmental action such as wind, rain and animal movements. A second pass with a planting implement will typically cut holes with predetermined inter and intra row spacings into the sheet mulch and install seeds or transplants into the planting bed. The result of the installation process is a fully planted bed of plants that has been installed with a minimum of human labor.

In the home garden or non-mechanized farm, the benefits of a sheet mulch/drip irrigation system remain high, but the costs of installation are substantially higher than with the use of mechanized equipment. The grower must prepare the soil and make careful measurements and field layouts, then install drip irrigation and hold it in place typically with stakes or rocks or partial burial, and subsequently install sheet mulch via hand trenching and burial of the edges of the sheet contending with varying soil and weather conditions such as high winds and wet or rocky soils. Finally planting holes can be spaced with manual methods, and hand-cut into the sheet mulch and plants or seeds may be installed. If desired the farmer can then add various row coverings to protect the crop from weather and pest damage. The manual process is slow and expensive and currently manufactured products are not well configured to facilitate manual installation.

In the mechanized farm at the end of the growing season, sheet mulches are typically removed from the field with yet another specialized piece of agricultural equipment—the mulch retriever. The mulch retriever will loosen and spill soil from the buried-in sheet mulch and gather it for storage or disposal.

On the non-mechanized farm, retrieval of the sheet mulch is another labor-intensive task. The mulch, tubing and row covers typically must be gathered, bagged and disposed of entirely by hand. This adds to disposal labor and cost, and the many parts complicate the process and expand the time.

A durable product that combines irrigation, mulching and row covering into a single installation suitable for multi-year use and easy installation and removal would represent a clearly useful innovation for the non-mechanized farm or home garden.

Sheet mulches are typically plastic films of polyethylene, or woven plastic mats made of polypropylene plastics. Drip irrigation is typically a tube of polyethylene with built in water emitters. There are several alternate embodiments of these basic components such as natural fiber sheet mulches like burlap or newsprint, and alternate watering methods such as soaker hoses and sprinklers. McGrady et al (US Patent Application Pub# US 2008/0072480 A1) teaches the use of a combination plastic mulch and drip irrigation system with built in seeds, and other prior art teaches new methods of water delivery and integrated seed delivery, and also new methods of manufacturing integrated drip and sheet mulch products (Kruer et al, US Patent Application Publication # US 2006/0032125 A1). No prior art, however specifically addresses the needs of non-mechanized farmers, small scale growers and home gardeners to have the benefits of these technologies for low cost at small scales of installation with scale-appropriate installation tools.

One additional limitation of the prior art, and the mechanized methods of installation is the fact that mechanized planters allow for specific inter and intra row plant spacings, but do not allow for relationship of specific plants to each other. The result is at best a square-grid of plants, where the distance from plants across the diagonal of the square is greater than the distance from plants along the edge of the square. The result is that plant spacings vary from optimal spacings, as excessive gaps in the plant canopy can result in weed growth, and sub-optimal per-area plant yields due to the wasted space.

All references cited herein are incorporated herein by reference in their entireties.

### BRIEF SUMMARY OF THE INVENTION

An agricultural system includes an irrigation system, a mulch system including mulch material, and indicia disposed on the mulch material for indicating locations on the mulch material. The indicia include burial indicia. The indicia include conduit warning indicia. The indicia include plant spacing indicia. The planting spacing indicia are disposed in a triangular grid on the mulch system. The mulch material includes at least one hole for planting. The mulch material includes at least one hole for a stake to pass there through. The mulch material includes at least one hole for a row cover support to pass there through. The irrigation system includes a drip irrigation conduit.

The irrigation system includes a further conduit for transporting water to a further irrigation system. The irrigation system includes a fitting and a manifold for transporting water to the further conduit. At least a portion of the irrigation system is bonded to the mulch system. At least a portion of the irrigation system is enclosed and maintained in the vicinity of the mulch system by a sleeve. The agricultural system includes a further comprising a row cover system.

### BRIEF DESCRIPTION OF SEVERAL VIEWS OF THE DRAWINGS

The invention will be described in conjunction with the following drawings in which like reference numerals designate like elements and wherein:

FIG. 1 shows a sectional top view generally taken on line 1-1 of FIG. 5 of a pre-cut mulch section with row cover supports and drip irrigation extending beyond the mulch section. The row cover piece is not shown.

FIG. 2 shows a bottom view generally taken on line 2-2 of FIG. 5 of pre-cut mulch section with drip irrigation.

FIG. 3 shows a cross-sectional view generally taken on line 3-3 of FIG. 5 through a pre-cut mulch section with row cover and row cover supports. The drip irrigation tubing to mulch connection may be via bonding, welding or gluing.

FIG. 4 shows a cross-sectional view generally taken on line 4-4 of FIG. 5 through a precut mulch section with row cover and row cover supports. The drip irrigation tubing can be mated with the mulch with an alternate sleeve construction.

FIG. 5 shows a side elevation of mulch section with row cover in place over row cover supports.

FIG. 6 shows a top view with the row cover in place.

FIG. 7 shows an alternate installation method using direct burial of the mulch edge in soil and the staking used to secure the open row cover edge. The cross-sectional view is generally taken on line 3-3 of FIG. 5.

FIG. 8 shows a pre-marked roll of mulch without pre-cut holes and with the various markings useful for installation and use. No row cover is shown.

FIG. 9 shows a pre-cut roll of mulch without row cover.

### DETAILED DESCRIPTION OF THE INVENTION

The invention consists of three integrated systems most clearly illustrated in the drawings. The first system as shown in the drawings is the irrigation system comprised of flexible water piping 10, drip irrigation tubing 11, and various fittings 13 and manifold piping 12. The second system is the mulch system comprised of mulch material 9, planting hole(s) 6, stake hole(s) 1, row cover support holes 14, direct burial printed marking 3, piping warning printed marking(s) 7, plant spacing marking(s) 19, seam 2 and edge 8. The third system is the row cover system comprised of row cover supports 5, row cover support holes 14, and the row cover 17. The irrigation system tubing components 10 and 11 can be connected either directly to mulch material 9 with a bonding method, or indirectly via insertion into sleeve 18. The mulch system is connected to the row cover system at seam 2 via bonding or stitching. The invention in any of its embodiments can be attached to the soil 16 via insertion of stakes 18 into stake-holes 1 and then into the soil 16, or alternatively via direct burial of the edge of mulch 9 into soil 16.

The indicia of the present invention may be any type of indicia suitable for indicating locations on the mulch material, for example indicia that are visible on the surface of mulch material 9, such as a solid line, a dotted or dashed line, or a color line. Furthermore, the indicia can be, for example, perforations in or fully punched holes through the mulch material 9. Additionally, the conduits and piping in the present invention can be any type of conduits known to those skilled in the art suitable for transporting water.

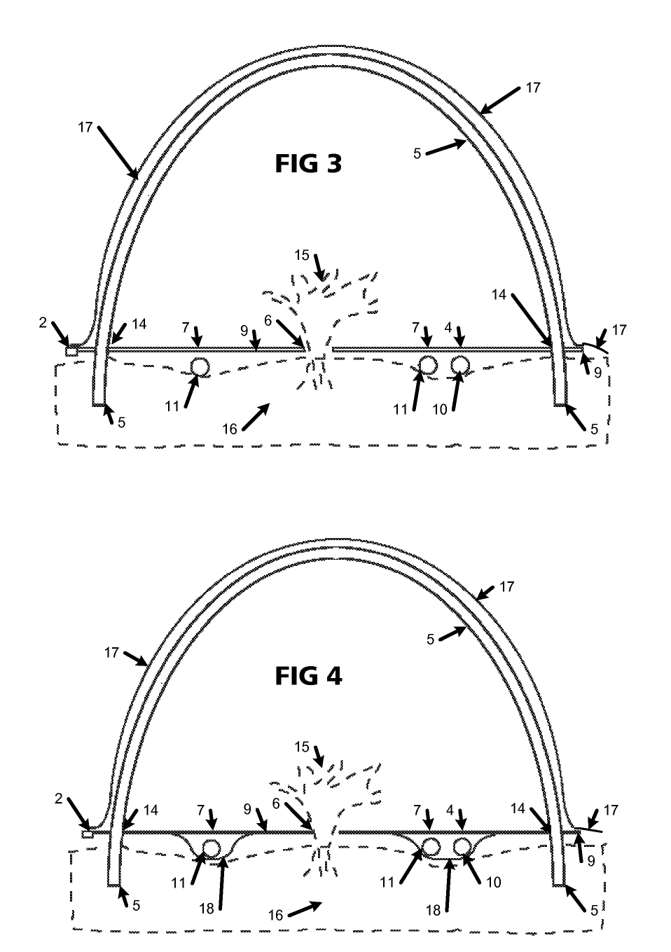

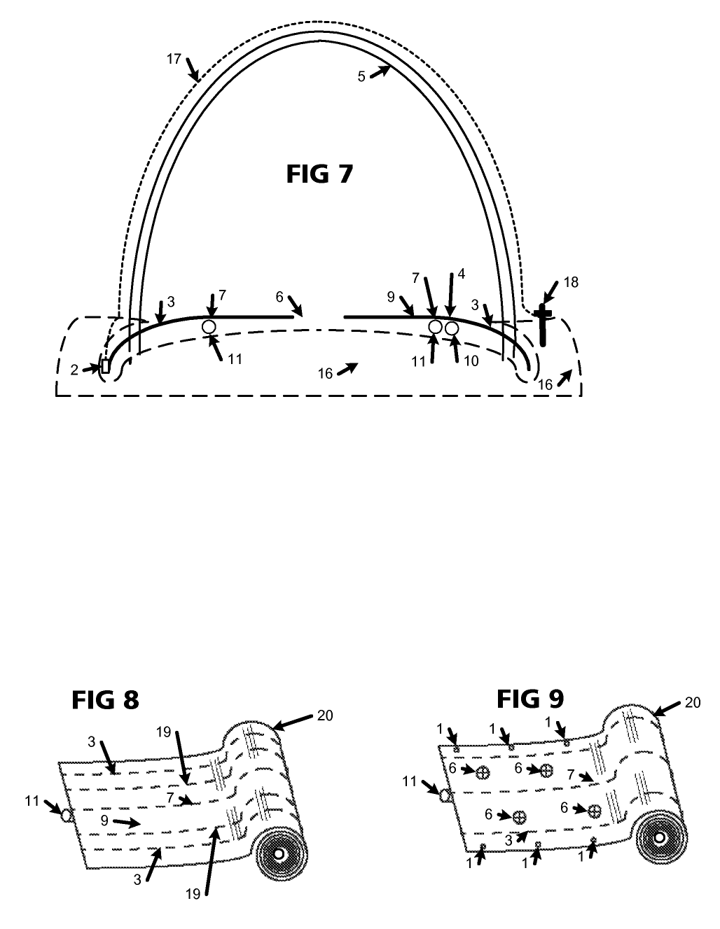

Regarding the irrigation system (10,11,12,13), the method of connection between the mulch material 9 and the drip irrigation tubing 11 and flexible water piping 10 results in labor and material saving for the non-mechanized farmer by reducing the steps needed to separately install the elements. See, especially, FIG. 3, FIG. 4, and FIG. 7. Depending upon the material selected for mulch material 9 and the drip irrigation tubing 11 and flexible water piping 10, the connection to the mulch material 9 may be via gluing, welding, or stitching that forms a direct and permanent connection, or via the use of sleeve material 18 that would form a fabric sleeve into which loose and unbonded piping 10 or drip irrigation tubing 11 could be inserted. See FIG. 3 and FIG. 7, especially, for the direct connection assembly method of connecting mulch material 9 to tubing 10,11. The connection point can be at the top of the tubing 10,11 and on the adjacent mulch material directly beneath the printed markings 7,4. See FIG. 4, especially, for the indirect connection method that shows sleeve 18. The details of the irrigation system (10,11,12,13) pertaining to plumbing, valving, spacing of drip emitters in drip irrigation tubing 11, and manifold 12 construction are not of particular interest in this invention, but the components (10,11,12,13) will vary in number to suit specific crop 15 to be planted and water supply requirements and are best viewed in FIG. 2. For example the flexible water piping 10 can be eliminated if there is no need to transport water past the boundaries of the invention, and the number of drip irrigation tubes 11 can be increased or reduced as appropriate to the crop and water supply. Regarding alternate means of construction using sleeve 18, the sleeve can be of water permeable construction so that water from drip irrigation tubing 11 can penetrate and enter the soil 16.

Regarding the mulch system (1,2,3,4,6,7,8,9,14,19), the construction of the invention may vary depending upon the selection of mulch material 9. A lightweight mulch material 9 such as thin polyethylene that is easy to cut does not require the cutting of holes 6,1,14; however, in the absence of holes 6,1,14, indicia such as printed markings 3,7,19 can be placed to guide the installer so that plants 15 can be spaced with accuracy and avoid drip irrigation tubing 11. These indicia, suitable for use in indicating locations on the mulch system, are novel and of benefit to the user and may be any type of indicia known to those skilled in the art. This thin film configuration is shown, especially, in FIG. 8. Alternately more durable mulch material 9 such as woven polypropylene, or burlap or other heavy weight woven fabrics will likely require cutting of holes 6,1,14. Even heavy mulch material 9 may benefit from indicia such as printed markings 3,7,4 in the event that the invention is modified after manufacturing. Additionally, holes 6,1,14 can save field labor and improve plant spacing reliability. A roll 20 version of the durable mulch material 9 with holes 1,6 is shown in FIG. 9.

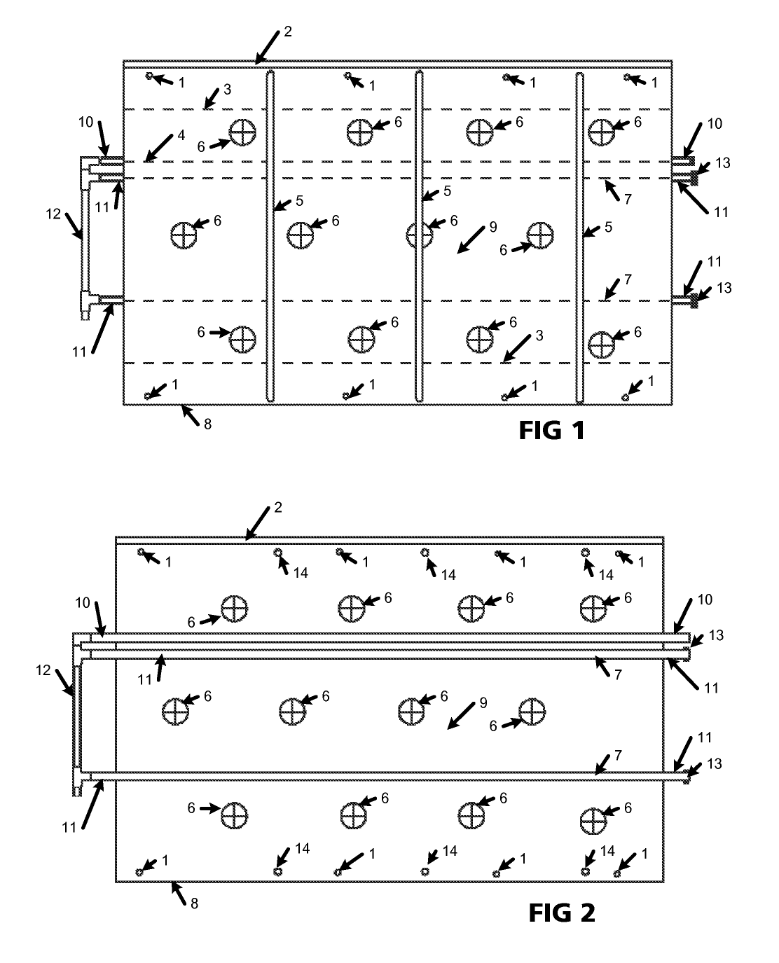

Similar to the irrigation system variability in construction in consideration of target crop 15 and water supply, the exact geometry such as diameter of and space between indicia or holes 6,1,14 and indicia or markings 3,7,4,19 can vary. In the case of plant holes 6, the ideal geometry can be upon a triangular grid such that each hole can be spaced evenly in relationship to every other hole. Likewise, on a lightweight mulch material 9, printed plant markings 19 might similarly indicate the preferred triangular spacing. To illustrate several embodiments with differing hole and plant spacings, compare FIG. 1 which has three rows of holes 6 and two rows of drip irrigation tubing 11 with FIG. 9 which has two rows of holes and a single drip irrigation tubing 11.

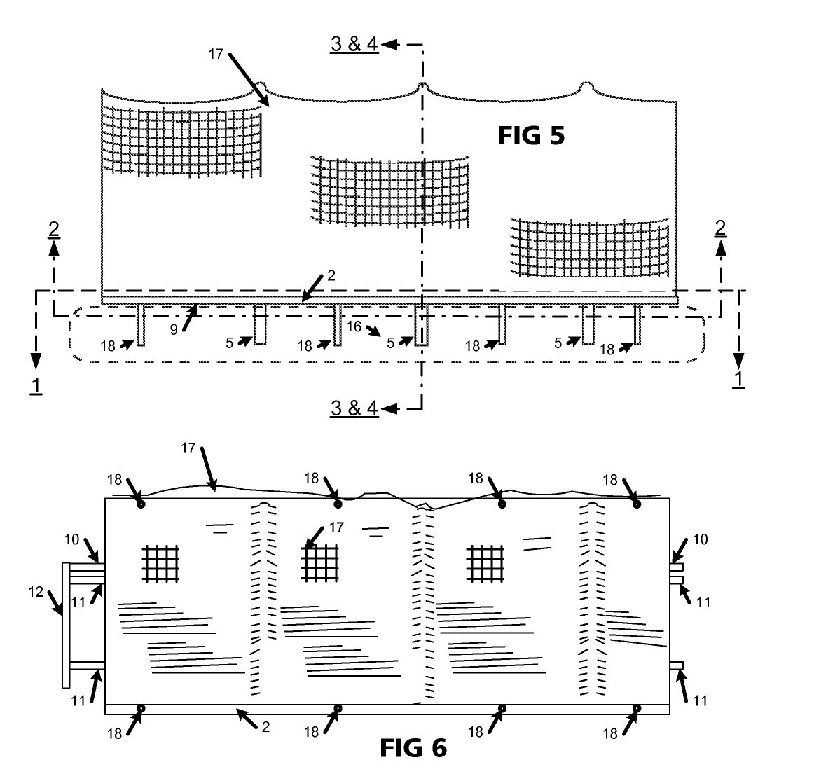

Regarding the row cover system 17,5,14, a novelty of this invention can be related to the attachment of mulch material 9 to row cover material 17 via seam 2. A wide variety of row cover 17 materials exist, and the exact nature of seam 2 can be determined by analysis of materials but can generally be welding, gluing, stapling or stitching. Seam 2 can extend down one length of mulch material 9 so that crop 15 is accessible from the opposite side. The free edge of row cover 17 can be passed over row cover support 5 and then connected to soil 16 via use of stakes 18, or weights such as rocks or soil 16 that can keep the loose edge secured. To install row cover support 5 into mulch material 9 the end of row cover support 5 can be passed through hole 14 and secured by embedment into soil 16. FIG. 5 shows a side view of the invention with a row cover 17 as indicated by the screen-like mesh. The three bumps at the top of the figure represent row cover supports 5. FIG. 6 shows the row cover from the top to reveal the seam 2 edge and the loose row cover 17 edge secured into the ground 16 with stakes 18. These stakes can pass through row cover 17, through hole 14 in mulch material 9 before embedding in soil 16, or might simply pass through row cover 17 and directly into soil 16.

To use one embodiment of the invention, place a rolled embodiment of invention 20 on prepared soil 16 and unroll the embodiment such that irrigation piping (10,11) is in contact with the soil, and either insert stakes 18 and or row cover supports to secure the embodiment to soil or bury edge of the embodiment in soil up to the point that direct burial printed marking 3 remains visible. If mulch material 9 has plant holes 6, insert plant 15 or seed in place of plant 15 into soil. If mulch material 9 has only printed plant indicia 19, cut or tear mulch material 9 at appropriate spacing and insert plant 15 into soil 16. Connect drip irrigation system via direct connection to drip irrigation tubing 11, or to irrigation manifold 12 to water main or other pressurized water system. Terminate tubing 10,11 with fittings 13 as appropriate to maintain a pressurized drip irrigation system. Clear row cover material 17 from mulch material 9 and insert row cover supports 5 into hole 14. Pass row cover material 17 over row cover support 5 and secure loose edge of row cover material into ground via burial or use of stakes 18. At the end of an embodiment, there are numerous methods available to the farmer that can serve to close off the end of row cover 17 and prevent the entry of bad weather and or pests. The system can be installed with less effort and cost than is typically available to non-mechanized growers and results in better space efficiency than is available to even the mechanized grower.

Thus it will be understood by those skilled in the art that this invention combines the agricultural innovations sheet mulch, drip irrigation and protective row covers in an easy to install package suitable for growers without access to mechanized farm equipment.

While the invention has been described in detail and with reference to specific examples thereof, it will be apparent to one skilled in the art that various changes and modifications can be made therein without departing from the spirit and scope thereof.

What is claimed is:

1. An agricultural system, comprising:
an irrigation system,
a mulch system including mulch material, and
indicia disposed on the mulch material for indicating locations on the mulch material.

2. The agricultural system of claim 1, wherein the indicia comprise burial indicia.

3. The agricultural system of claim 1, wherein the indicia comprise conduit warning indicia.

4. The agricultural system of claim 1, wherein the indicia comprise plant spacing indicia.

5. The agricultural system of claim 4, wherein the planting spacing indicia are disposed in a triangular grid on the mulch system.

6. The agricultural system of claim 1, wherein the mulch material comprises at least one hole for planting.

7. The agricultural system of claim 1, wherein the mulch material comprises at least one hole for a stake to pass there through.

8. The agricultural system of claim 1, wherein the mulch material comprises at least one hole for a row cover support to pass there through.

9. The agricultural system of claim 1, wherein the irrigation system comprises a drip irrigation conduit.

10. The agricultural system of claim 9, wherein the irrigation system comprises a further conduit for transporting water to a further irrigation system.

11. The agricultural system of claim 10, wherein the irrigation system comprises a fitting and a manifold for transporting water to the further conduit.

12. The agricultural system of claim 1, wherein at least a portion of the irrigation system is bonded to the mulch system.

13. The agricultural system of claim 1, wherein at least a portion of the irrigation system is enclosed and maintained in the vicinity of the mulch system by a sleeve.

14. The agricultural system of claim 1, further comprising a row cover system.
